(19) United States
(12) Patent Application Publication
(10) Pub. No.: US 2019/0270155 A1
(43) Pub. Date: Sep. 5, 2019

(54) METHOD FOR MANUFACTURING A CELLULAR STRUCTURE

(71) Applicant: SAFRAN AIRCRAFT ENGINES, PARIS (FR)

(72) Inventors: Julien ARNOULD, MOISSY-CRAMAYEL (FR); Jean-François Didier CLEMENT, MOISSY-CRAMAYEL (FR); Bruno GIARDINI, MOISSY-CRAMAYEL (FR)

(21) Appl. No.: 16/302,183

(22) PCT Filed: Mar. 31, 2017
(86) PCT No.: PCT/FR2017/050763

§ 371 Date: Nov. 16, 2018

(30) Foreign Application Priority Data
May 18, 2016 (FR) 1654430

(51) Int. Cl. B23K 1/20; B23K 1/008; B23K 1/00; F01D 11/12

(52) U.S. Cl. CPC B23K 1/20; B23K 1/008; B23K 2101/001; F01D 11/127; B23K 1/0014

(57) ABSTRACT

The invention relates to a method for manufacturing a cellular structure comprising the following steps:
a) providing a plurality of metal sheets (126) each having, in a first direction, undulations formed by a succession of vertex areas (28) alternately arranged with junction areas (30);
b) juxtaposing the sheets (126) so as to form cells;
c) placing a first (26a) end of each sheet (126) in contact with a support plate;
d) arranging a soldering element between the support plate (34) and the first ends (26a) of the sheets (126) and heating the assembly in a furnace.

According to the invention, the method consists, prior to step d), in adding a means for blocking the diffusion of solder from said first ends (26a) of the sheets (126) to the second free ends (26b) of the sheets (126).

The present invention relates to a method for manufacturing a cellular structure intended, in particular, to seal the top of the blades of an impeller.

Typically a turbine comprises a rotating assembly including a plurality of impellers connected to each other and arranged axially alternately with annular rows of stator blades carried externally by a turbine case.

To limit air flow between the radially outer ends of the impeller and the turbomachine casing, it is known that a plurality of blocks or panels made of abradable material are arranged around the impeller, circumferentially end to end, which are intended to cooperate in a sealed manner with rubbing strips carried by the platforms of the blade tips. The blocks of abradable material are attached to the outer casing by C-shaped hooks engaged on circumferential rails on the inner side of the outer casing.

A block of abradable material is formed by a plurality of semi-hexagonal shaped metal sheets joined together so as to form a structure with hexagonal cells. More generally, each sheet comprises, in a first direction, undulations formed by a succession of so-called vertex areas alternating with junction areas of said vertex areas.

According to the known technique, the sheets are assembled together so that the vertex areas come into contact with each other and are maintained in this state. A support plate is then mounted in contact with a first end of the sheets, in a second direction perpendicular to the first direction, and a soldering element such as paste and/or powder is placed in contact with the first ends of the sheets and the support plate. The assembly is then heated in a furnace to ensure that the sheets are firmly attached to each other and to the support plate.

Although this method for manufacturing the abradable block or panel is satisfactory in terms of its mechanical strength, it appears that solder can spread by capillary action from the first ends of the sheets to the second ends opposite said first ends. The presence of solder at the second ends of the sheets of the abradable panel leads to an increase in the average hardness of said second ends, which can damage the blade tips and induce premature wear thereof. In addition, the hardness of the second ends of the abradable panel can be further increased if an eutectic substance is formed from the material constituting the sheets of the abradable and the soldering element.

The invention more particularly aims at providing a simple, efficient and cost-effective solution to the problems of the prior art disclosed above.

To this end, it proposes a method for manufacturing a cellular structure, in particular of the abradable structure type for a turbomachine, including the steps of:
a) providing a plurality of metal sheets each having, in a first direction, undulations each formed by a succession of so-called vertex areas alternately arranged with junction areas of said vertex areas;
b) juxtaposing the sheets so that said first directions of said sheets are parallel two by two, with the vertex areas of a sheet being placed in contact with the vertex areas of the adjacent sheet(s) to form cells;
c) placing a first end of each sheet, in a second direction perpendicular to the first direction, in contact with a support plate;
d) arranging a soldering element between the support plate and said first ends of the sheets and heating the assembly in a furnace;
   characterized in that it comprises a step prior to step d) of adding means for blocking the diffusion of solder from said first ends of the sheets to the second free ends of the sheets.

The addition of a solder blocking means at the vertex areas prevents the solder from spreading to the second free ends of the metal sheets intended to come into contact with the blade tips. The result is better hardness control to ensure longer blade life and reduce associated maintenance time.

According to another characteristic, the solder diffusion blocking means is formed on said vertex areas of the sheets, prior to step b).

In a first possible embodiment of these means, cutouts are provided in at least some of the vertex areas of the metal sheets.

In a second embodiment, said means comprises a liquid repellent product applied to at least some of the contacting faces of the vertex areas of the metal sheets.

It would still be possible to combine cutouts with a liquid repellent product.

Preferably, the undulations of each sheet form a semi-hexagonal pattern.

For example, the cutouts may have a dimension of about 0.5 mm, as measured in said second direction.

The cutouts can be substantially rectilinear in the first direction.

Each sheet can have a corrugated guide curve extending in said given direction and a generator extending in the second direction. With this type of configuration, each sheet has a symmetry plane that includes the first and second directions.

The invention will be better understood, and other details, characteristics and advantages of the invention will appear upon reading the following description given by way of a non restrictive example while referring to the appended drawings wherein:

FIG. 1 is a schematic axial cross-sectional view showing the cooperation between a panel of abradable material and an end of a revolving blade;

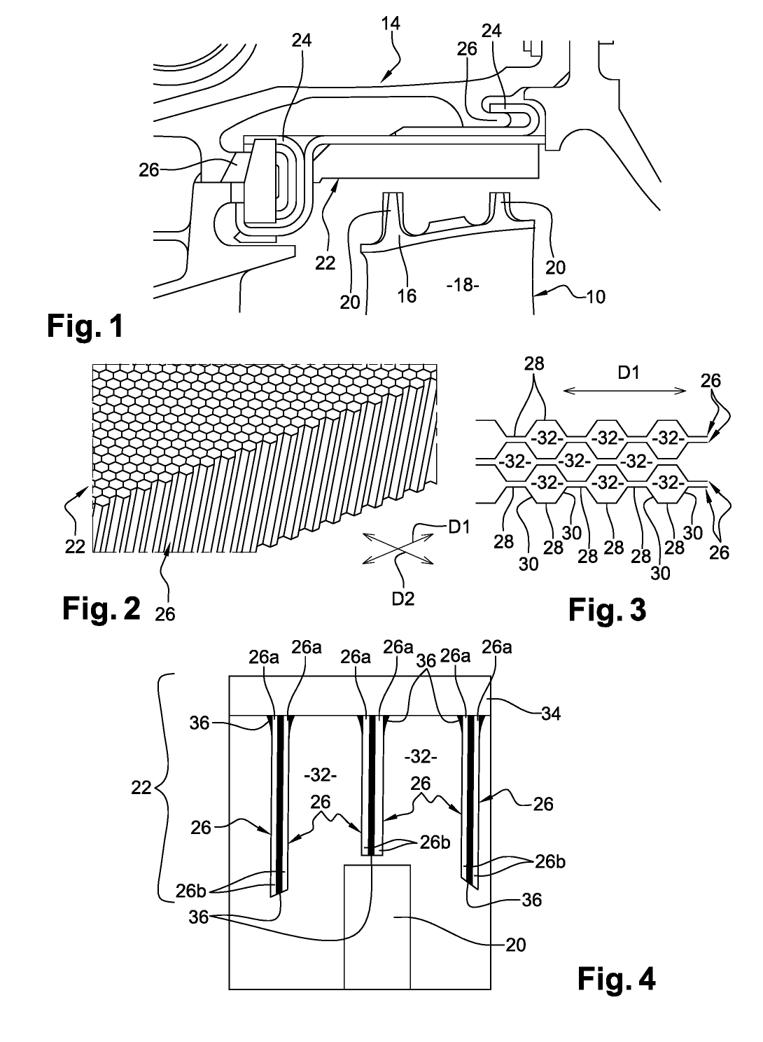

FIG. 2 is a schematic perspective view of an abradable panel of a known type;

FIG. 3 is a schematic cross-sectional perspective view along a plane perpendicular to the thickness of the abradable panel of FIG. 3;

FIG. 4 is a schematic view showing in particular the cooperation between a rubbing strip at the end of a revolving blade and the abradable panel;

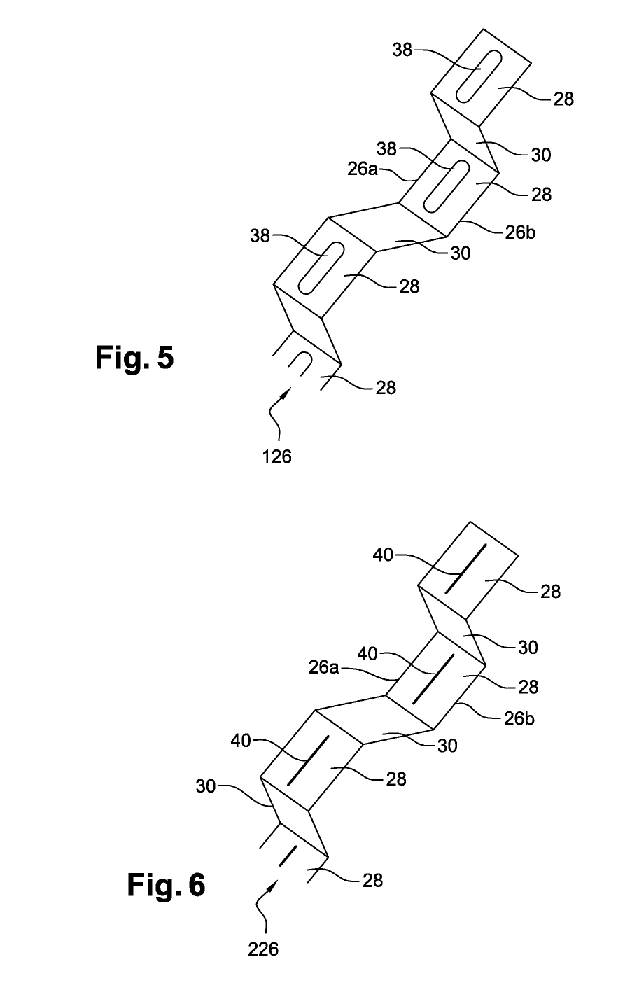

FIG. 5 is a schematic perspective view of an abradable panel according to a first embodiment of the invention;

FIG. 6 is a schematic perspective view of a sheet of an abradable panel according to a second embodiment of the invention;

Reference is first made to FIG. 1, which represents the radially outer end area of a revolving blade of a low-pressure turbine. The rotor of the low-pressure turbine comprises a plurality of annular rows of blades 10 arranged axially in staggered rows with annular rows of stationary blades 12 supported externally by an outer annular casing 14. Each revolving blade 10 comprises an inner annular platform (not shown) and an outer annular platform 16 between which blades 18 extend. The outer annular platform 16 has on its radially outer annular surface, opposite the blade 18, a plurality of substantially radial 20 rubbing strips. These rubbing strips 20 cooperate by friction with an annular panel 22 made of abradable material carried by the outer casing 14 to ensure sealing at the top of the revolving blade 10, i. e. to limit the circulation of parasitic air between the top of the revolving blades 10 and the casing 14.

The panel 22 made of abradable material comprises external C-shaped components 24 open in the upstream direction and each one being circumferentially engaged on a circumferential rail 26 supported by the outer casing 14.

An abradable panel 22 as shown in FIG. 2 is made of a plurality of semi-hexagonal patterned metal sheets 26 (FIGS. 2 and 3). The sheets 26 have been deliberately separated from each other in FIG. 3 in order to better distinguish them from each other.

In general, each sheet 26 comprises undulations extending in a first direction D1 and formed by a succession of so-called vertex areas 28 alternating with junction areas 30 of said vertex areas 28. The abradable panel 22 consists of several sheets 26 juxtaposed one to the other, with the vertex areas 28 being brought into contact and the first directions D1 of the sheets 26 being parallel two by two.

In the configuration shown in FIGS. 2 and 3, the vertex areas 28 and junction areas 30 are flat and are so arranged relative to each other as to form a semi-hexagonal pattern which, by contacting the vertex areas 28 as described above, forms a block of abradable material 22 including hexagonal cells 32.

As shown in FIG. 4, a first end 26a of the sheets 26 is brought into contact with a support plate 34. A soldering element is arranged between the support plate 34 and the first ends 26a of the sheets 26 so as to provide a connection between these elements when being subsequently heated in a furnace.

FIG. 4 also shows the solder 36 for connecting the sheets 26 to each other and the sheets 26 to the support plate 34. It is clear that the solder 36 extends between the sheets 26, more particularly between two vertex areas 28, from the first ends 26a of the sheets 26 to their second opposite ends 26b. In practice, the first ends 26a are, in this case, ends arranged, relative to the axis of the turbine, radially on the outside and the second ends 26b are ends arranged radially on the inside and are intended to rub with the rubbing strips 20 to provide sealing. As explained above, the presence of solder 36 in contact with the rubbing strips 20 is likely to damage the rubbing strips 20 and therefore reduce the tightness of the assembly.

The invention thus proposes to add a means for blocking the diffusion of solder up to the second free ends 26b of the sheets 26 of the abradable panel 22 in order to reduce the average hardness of this area and thus avoid damaging the rubbing strips 20 of the blades 10 and restore a good sealing to hot flows during operation.

In a first embodiment shown in FIG. 5, the method for manufacturing the abradable panel 22 with a cellular structure consists in making cutouts 38 in the vertex areas 28 of the sheets 26. The cutout 38 thus created limits the capillary diffusion of the liquid solder 36 to the second ends 26b of the sheets 126. This effect is explained by the absence of physical support for the diffusion of solder 36.

The cutout 38 can have a dimension of about 0.5 mm, as measured in the second direction D2 perpendicular to the first direction D1 (see FIG. 2). As shown, the cutouts 38 can have a substantially rectilinear shape in the first direction D1, with curved ends.

In a second embodiment of a sheet 226 shown in FIG. 6, the cutouts 38 can be replaced by a liquid repellent product 40, having the property of limiting the solder flow from the first end 26a to the second end 26b of the sheet 226. A liquid repellent agent can be, for example, boron nitride packaged in an aerosol so that it can be sprayed at the desired location. These products, also known as “Stop-Off” products, are marketed by Wesgo Metals under the name Stopyt® or Wall Colmonoy Limited under the name Nicrobraz®. A mask with an opening can be applied to a sheet 226 to apply the liquid repellent product.

In either one of the embodiments described above, it is understood that a cutout 38 can be made or the application of a liquid repellent product limiting the diffusion/propagation of solder 36 can be carried out on every other sheet 126. According to another possible embodiment, it would still be possible to add the means for blocking the diffusion of solder 38, 40 only on one out of two vertex areas 38 in the first direction D1 but on all sheets 126.

In yet another embodiment, it would be possible to provide cutouts 38 on some of the vertex areas 28 and to apply a liquid repellent product 40 on the vertex areas 28 at the ends of the cutouts 38, in the first direction D1.

To achieve the initial mechanical strength of the assembly formed by the sheets 126, 226 and the support plate 34, punching operations can be performed on the sheets 126, 226 together and on the sheets 126, 226 with the support plate 34.

Also, the addition of solder can be done in several ways. The first one simply consists in inserting the solder into the cells 32 on the support plate 34 and placing the assembly into the furnace. The second one, known as “tape” soldering, consists in applying a seam of soldering paste onto the first ends of the sheets and pressing it so that it penetrates into the cells 32. The support plate 34 is then applied.

Although the invention has been described with reference to an external annular platform of a low-pressure turbine, it should be understood that the invention applies to other parts of the turbomachine that require friction-sealed cooperation between a stationary abradable panel and a mobile part. Thus, for example, the abradable panel described above could be used on a stationary annular part arranged radially opposite the radially inner end of revolving blades.

1.-6. (canceled)

7. A method for manufacturing a cellular structure, in particular of the abradable structure type for a turbomachine, comprising the following steps:
a) providing a plurality of metal sheets (126, 226) each having, in a first direction (D1), undulations each formed by a succession of so-called vertex areas (28) alternately arranged with junction areas (30) of said vertex areas (28);
b) juxtaposing the sheets (126, 226) so that said first directions (D1) of said sheets are parallel two by two, with the vertex areas (28) of a sheet (126, 226) being placed in contact with the vertex areas (126, 226) of the adjacent sheet(s) (126, 226) to form cells (32);
c) placing a first (26a) end of each sheet (126, 226), in a second direction (D2) perpendicular to the first direction (D1), in contact with a support plate (34);
d) arranging a soldering element (36) between the support plate (34) and said first ends (26a) of the sheets (126, 226) and heating the assembly in a furnace;
with the method comprising a step prior to step d) of adding means for blocking the diffusion of solder from said first ends (26a) of the sheets (126, 226) to the second free ends (26b) of the sheets (126, 226), characterized in that the solder diffusion blocking means comprises cutouts (38) provided in at least some of the vertex areas (28) of the metal sheets (126, 226).

8. A method according to claim 7, characterized in that the solder diffusion blocking means comprises a liquid repellent agent (40) applied to at least some of the contacting faces of the vertex areas (28) of the metal sheets (126, 226).

9. A method according to claim 7, characterized in that the cutouts have a dimension of about 0.5 mm, as measured in the second direction (D2).

10. A method according to claim 8, characterized in that the cutouts have a dimension of about 0.5 mm, as measured in the second direction (D2).

11. A method according to claim 7, characterized in that the cutouts (38) have a substantially rectilinear shape in said first direction (D1).

12. A method according to claim 8, characterized in that the cutouts (38) have a substantially rectilinear shape in said first direction (D1).

13. A method according to claim 9, characterized in that the cutouts (38) have a substantially rectilinear shape in said first direction (D1).

14. A method according to claim 7, characterized in that each sheet (126, 226) has undulations forming a semi-hexagonal pattern.

15. A method according to claim 8, characterized in that each sheet (126, 226) has undulations forming a semi-hexagonal pattern.

16. A method according to claim 9, characterized in that each sheet (126, 226) has undulations forming a semi-hexagonal pattern.

17. A method according to claim 11, characterized in that each sheet (126, 226) has undulations forming a semi-hexagonal pattern.

18. A method according to claim 7, characterized in that each sheet (126, 226) has a corrugated guide curve extending in said given first direction (D1) and a generator extending in the second direction (D2).

19. A method according to claim 8, characterized in that each sheet (126, 226) has a corrugated guide curve extending in said given first direction (D1) and a generator extending in the second direction (D2).

20. A method according to claim 9, characterized in that each sheet (126, 226) has a corrugated guide curve extending in said given first direction (D1) and a generator extending in the second direction (D2).

21. A method according to claim 11, characterized in that each sheet (126, 226) has a corrugated guide curve extending in said given first direction (D1) and a generator extending in the second direction (D2).

22. A method according to claim 14, characterized in that each sheet (126, 226) has a corrugated guide curve extending in said given first direction (D1) and a generator extending in the second direction (D2).
